(19) United States
(12) Patent Application Publication
(10) Pub. No.: US 2018/0250186 A1
(43) Pub. Date: Sep. 6, 2018

(54) INVERSION METHODS AND APPARATUS

(71) Applicant: EXPECTATIONS, LLC, Puyallup, WA (US)

(72) Inventors: Christopher Henry Leier, Puyallup, WA (US); Lopin Wang, Taichung (TW)

(73) Assignee: EXPECTATIONS, LLC, Puyallup, WA (US)

(21) Appl. No.: 15/800,331

(22) Filed: Nov. 1, 2017

Related U.S. Application Data
(60) Provisional application No. 62/465,926, filed on Mar. 2, 2017.
(60) Provisional application No. 62/465,913, filed on Mar. 2, 2017.

(51) Int. Cl. A61H 1/02; A61H 1/00

(52) U.S. Cl. CPC A61H 1/0229; A61H 1/001; A61H 2201/1642; A61H 2203/0493; A61H 2201/1676; A61H 2201/0192; A61H 2201/1623

(57) ABSTRACT

An inversion apparatus includes a support frame configured to movably support an inversion table that extends from an upper end to a lower end. An assembly is mounted on the lower end to clamp a user's ankles and/or support a user's feet. A preferred ankle clamp has a front ankle brace that adjustably telescopes relative to a rear ankle brace. A preferred foot support adjustably rotates between three foot supporting positions, each of which is a unique distance from the ankle clamp.

### CROSS-REFERENCE TO RELATED APPLICATIONS

Disclosed herein is subject matter entitled to the earlier filing dates of U.S. Provisional Application No. 62/465,913, filed Mar. 2, 2017; and U.S. Provisional Application No. 62/465,926, filed Mar. 2, 2017.

### FIELD OF THE INVENTION

The present invention relates to exercise equipment, and more specifically, to methods and apparatus associated with inverting a person relative to an underlying floor surface.

### BACKGROUND OF THE INVENTION

Along with cardio exercise and strength exercise, stretching and/or body manipulation may be considered another fundamental form of exercise or physical fitness that is important for overall health and well being. One specific form of beneficial stretching and/or body manipulation may be accomplished by inverting one's body relative to an underlying floor surface. Some examples of known inversion apparatus are disclosed in U.S. Pat. Nos. 5,967,951, 7,052,448, 7,663,653, 7,118,518, 7,125,372, 7,507,192, 7,544,157, 7,585,264, 7,625,326, 7,625,327, 7,867,154, 8,051,512, 8,291,533, 8,480,543, 8,556,787, D551,725, D581,996, D617,855, D650,025, D650,026 and D664,220. An object of the present invention is to provide new and improved inversion apparatus.

### SUMMARY OF THE INVENTION

Generally speaking, the present invention may be described as improvements to inversion apparatus that support a user in an inverted position relative to an underlying floor surface. The improvements may be practiced individually and/or in various combinations.

One improvement may be described in terms of an ankle holder including at least one rear ankle support mounted on an inversion table to engage a user's ankles from behind; at least one front ankle support mounted on the inversion table to engage a user's ankles from in front; and an adjustment assembly interconnected therebetween to selectively telescopically adjust a distance defined between the front ankle support and the rear ankle support.

Another improvement may be described in terms of an ankle holder operable to clamp a user's ankles; a foot support including rotatably selectable left and right foot supporting surfaces for a user's left and right feet; and an adjustment assembly interconnected therebetween for selectively rotating the foot support to adjust a distance defined between the foot supporting surfaces and the ankle holder.

Various features and benefits of the present invention will become apparent from the more detailed description that follows.

### BRIEF DESCRIPTION OF THE DRAWING

With reference to the Figures of the Drawing, wherein like numerals represent like parts and assemblies throughout the several views:

FIG. 1 is an upper perspective view of a tilting inversion exerciser constructed in accordance with the present invention;

FIG. 2a is an enlarged partial perspective view illustrating a foot and ankle engaging assembly that is part of the tilting inversion exerciser of FIG. 1;

FIG. 2b is an enlarged perspective view similar to FIG. 2a, but illustrating an ankle clamping component in a different phase of operation;

FIG. 3 is a partial exploded alternative perspective view of the foot and ankle engaging assembly of FIGS. 2a and 2b;

FIG. 4 is partial exploded perspective view of the foot and ankle engaging assembly of FIG. 2a;

FIG. 5 is a partial cross-sectional side view illustrating an ankle clamp that is part of the foot and ankle engaging assembly of FIG. 2a, taken along a plane designated by line 5-5 in FIG. 2a;

FIGS. 6-10 are partial cross-sectional side views similar to FIG. 5, illustrating the ankle clamp of FIG. 5 in different phases of operation;

FIG. 11 is an enlarged perspective view of a knob that is part of the tilting inversion exerciser of FIG. 1;

FIG. 12 is an enlarged perspective view of a button that is part of the tilting inversion exerciser of FIG. 1;

FIG. 13 a partial exploded alternative perspective view of the foot and ankle engaging assembly of FIGS. 2a;

FIG. 14 is a partial cross sectional view illustrating a foot support that is part of the foot and ankle engaging assembly of FIG. 2a, taken along a plane designated by line 14-14 in FIG. 1;

FIG. 15 is a partial side plan schematic view illustrating the operation of the foot support of FIG. 14;

FIG. 16 is a partial cross sectional view of the foot support of FIG. 14, taken along a plane designated by line 16-16 in FIG. 2b;

FIGS. 17-20 are partial cross sectional views similar to FIG. 16, illustrating selective reorientation of a foot engaging component that is part of the foot support of FIG. 14; and

FIGS. 21-22 are partial side plan schematic views similar to FIG. 15, illustrating the operation of the foot engaging component in the orientations shown in FIGS. 19 and 20, respectively.

### DETAILED DESCRIPTION OF THE PREFERRED EMBODIMENT

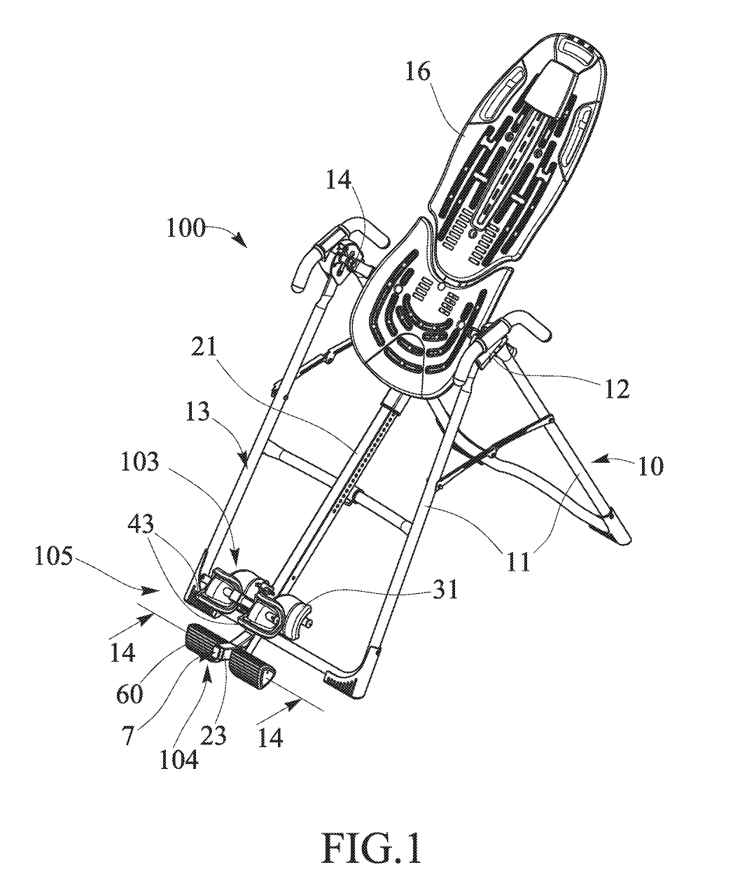

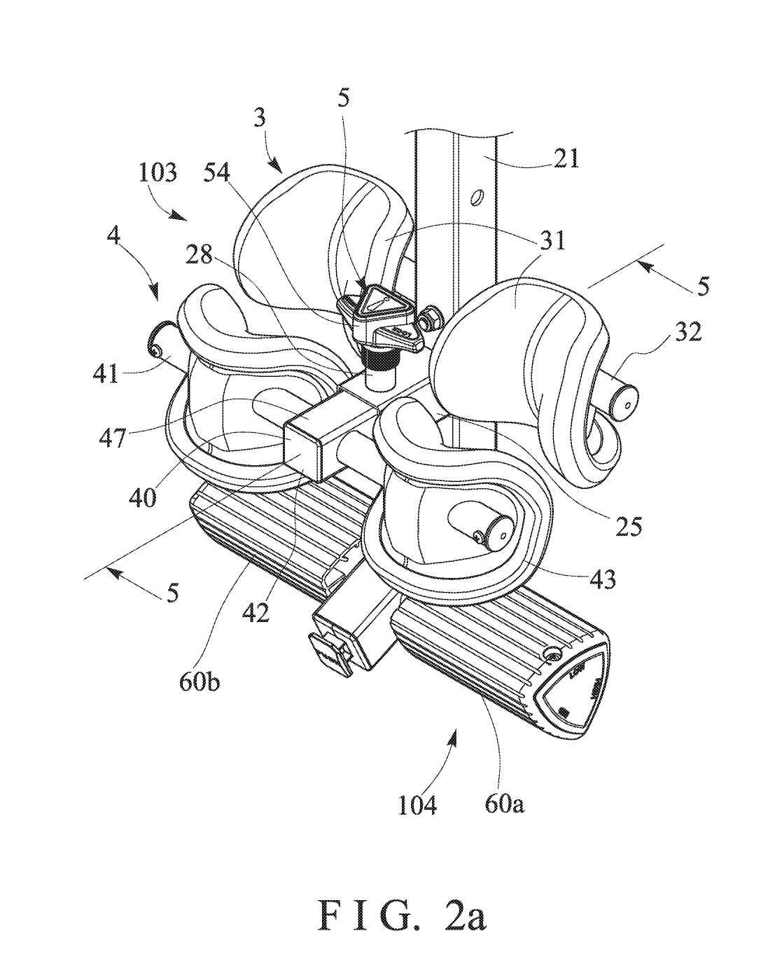

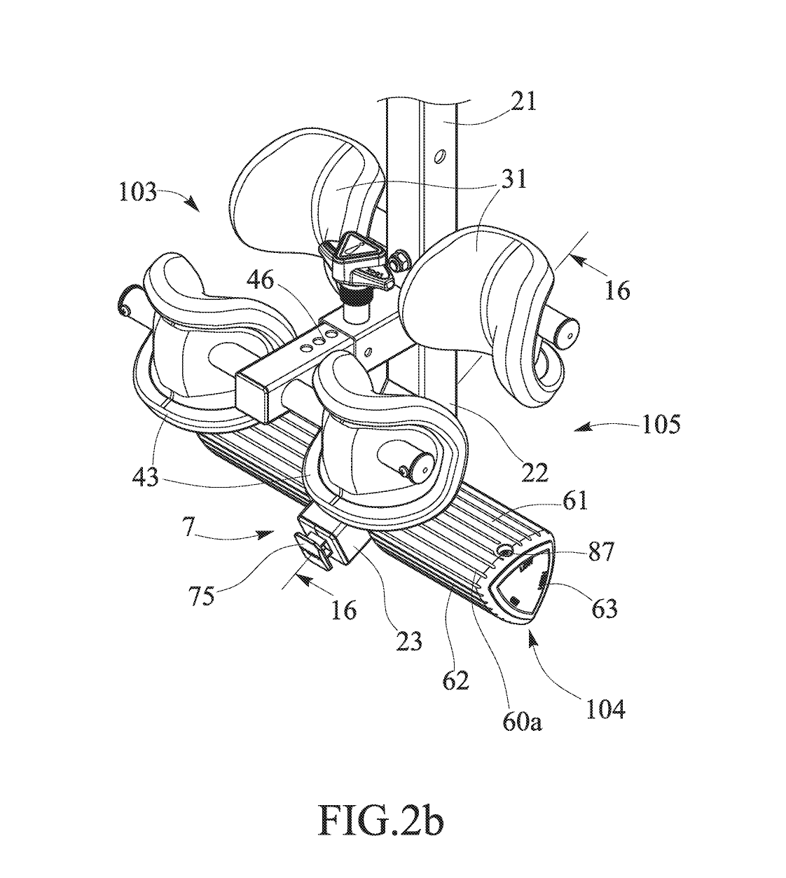

FIG. 1 shows a preferred embodiment inversion apparatus 100 constructed according to the principles of the present invention.

The apparatus 100 shares attributes with and/or may be implemented with components from one or more of the inversion apparatus disclosed in U.S. Pat. Nos. 5,967,951, 7,052,448, 7,663,653, 7,118,518, 7,125,372, 7,507,192, 7,544,157, 7,585,264, 7,625,326, 7,625,327, 7,867,154, 8,051,512, 8,291,533, 8,480,543, 8,556,787, D551,725, D581,996, D617,855, D650,025, D650,026 and D664,220, all of which are incorporated herein by reference.

The inversion apparatus 100 includes an inversion bed or table 16 that supports a user through a range of orientations relative to an underlying floor surface S, from approximately upright to completely upside down. The inversion apparatus 100 also includes a support frame or base 10 configured to occupy or rest in a stable position relative to an underlying floor surface. The support frame 10 supports the inversion table 16 at an elevation above the floor surface S for pivoting in a manner known in the art. This disclosure focuses on certain features with the understanding that other features of the inversion apparatus 100 may be gleaned from the above-referenced patents.

The base 10 includes two pairs of legs 11 having upper ends pivotally coupled together with two apex plates 12, thereby forming two inverted V-shaped or A-shaped frames 13. The table is pivotally or rotatably attached to and supported on the apex plates 12 of the base 10 with pivot axles 14, which pivot with the table 16 relative to the apex plates 12, between a normal status or non-inverted, ready position (see FIG. 1) and an up-side-down or inverted or active position.

The table 16 may be described in terms of a body supporting platform and an extension or bar 21 that is attached to and/or extends from the lower end of the platform. A foot engaging assembly or lower limb engaging assembly 105 is mounted on a lower end portion of the extension 21. The foot engaging assembly 105 may be described in terms of an ankle holder or clamp 103 and a foot rest 104, which cooperate to hold, retain, and/or position the feet and ankles of a user relative to the table 16. The extension 21 is preferably telescopically adjustable relative to the platform for moving or adjusting the ankle holder 103 and the foot rest 104 toward or away from the platform, according to the height or dimension of the user.

When the tilting inversion exerciser 100 occupies or is rotated to the relaxed or unloaded or non-inverted or generally upright position shown in FIG. 1, the feet F of the user may step onto the foot rest 104 with the backs of his ankles A resting against the pads 31 of the ankle holder 103. Then the anchor members or cuffs 43 may be adjusted and moved toward the anchor members or cuffs 31 to solidly and reliably and comfortably anchor or retain or clamp the user's ankles to the extension 21 of the table 16.

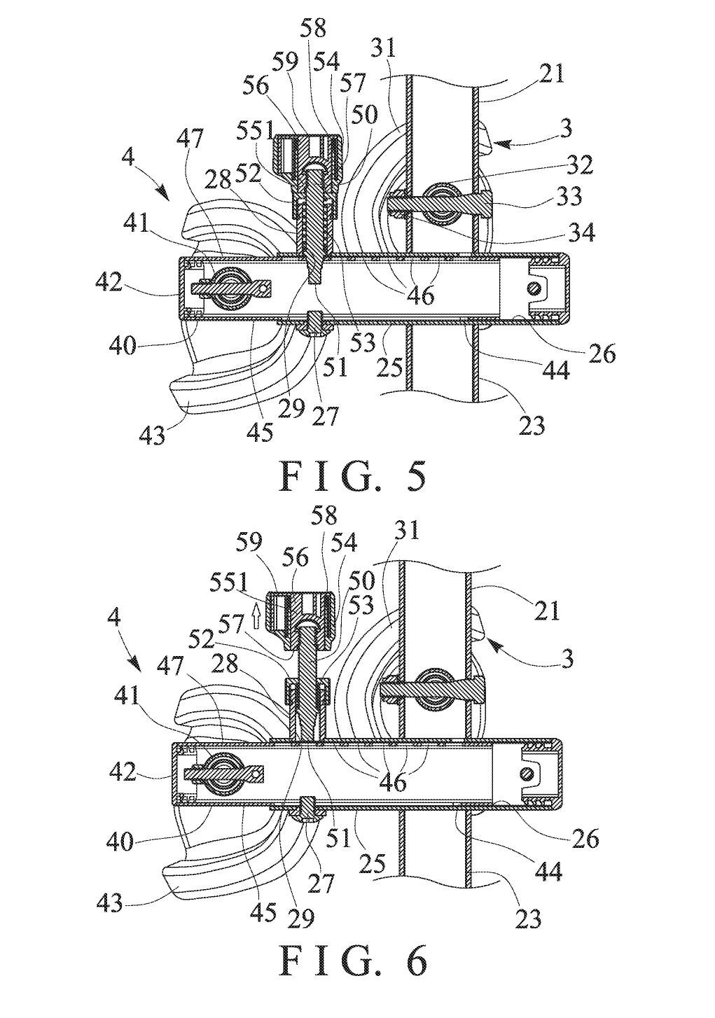

The ankle holder 103 includes a fixed rear ankle support 3 having left and right rear padded cuffs 31 attached to the extension 21 to comfortably engage with and support the backs of a user's ankles A. In this regard, a cylindrical tube or hollow rod 32 extends laterally through a hole in the extension 21, and is secured in place by a bolt 33 and a nut 34, as shown in FIG. 5, for example. The left cuff 31 slides onto an outwardly projecting left end of the rod 32, and the right cuff 31 slides onto an outwardly extending right end of the rod 32. The cuffs are free to pivot about the rod 32 subject to frictional resistance.

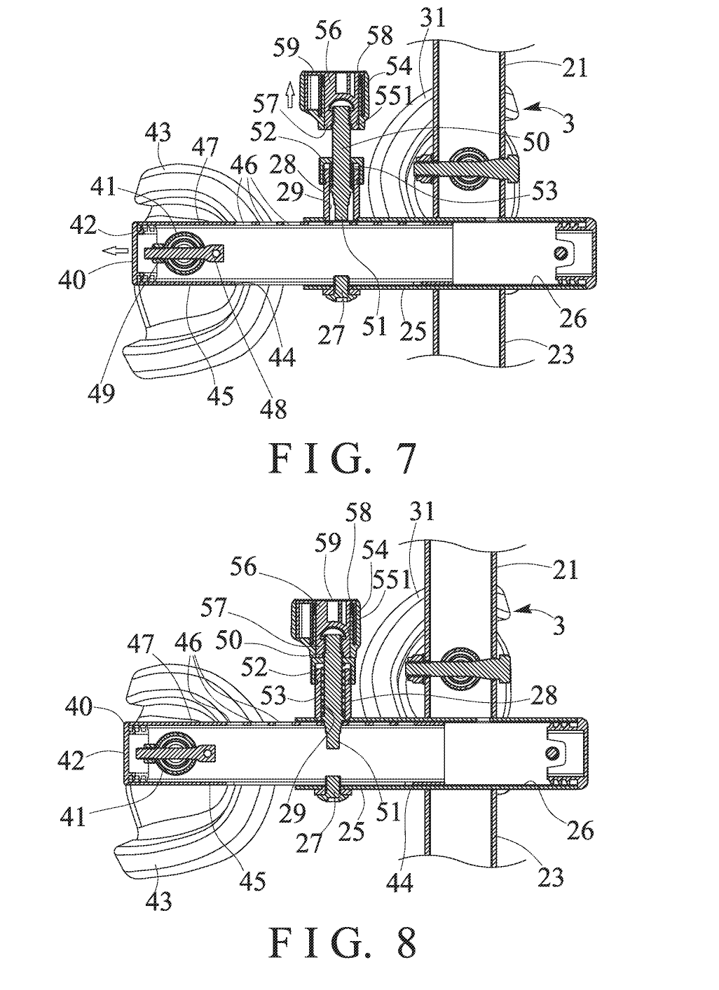

The ankle holder 103 also includes an adjustable front ankle support 4 having left and right front padded cuffs 43 attached to the extension 21 to comfortably engage with and support the fronts of a user's ankles A. In this regard, a square tube or shank or support 25 extends forwardly through a hole in the extension 21, proximate its lower distal end (and beneath the bolt 32). The shank 25 preferably extends perpendicularly through the extension 21, and is welded in place. The shank 25 defines a compartment or chamber 26 having an open or unobstructed forward end. A column or stem 40 is slidably mounted or engaged in the chamber 26 of the shank 25 and projects out the forward end. A cylindrical tube or hollow rod 41 extends laterally through a hole in the stem 40, proximate a forward end 42 of the stem 40, and is secured in place by a bolt 48 and a nut 49, as shown in FIG. 7, for example. The left cuff 43 slides onto an outwardly projecting left end of the rod 41, and the right cuff 43 slides onto an outwardly extending right end of the rod 41. The cuffs 43 are free to pivot about the rod 41 subject to frictional resistance.

As further explained below, the cuffs or anchor members 43 may be adjusted and moved toward or away from the cuffs 31 to accommodate the ankles of various users. In other words, people of different dimensions and/or standards may be suitably and snugly fitted and engaged between respective pairs of cuffs 31 and 43, thereby solidly and stably anchoring or retaining or positioning the ankles of the user to the extension 21 of the table 201.

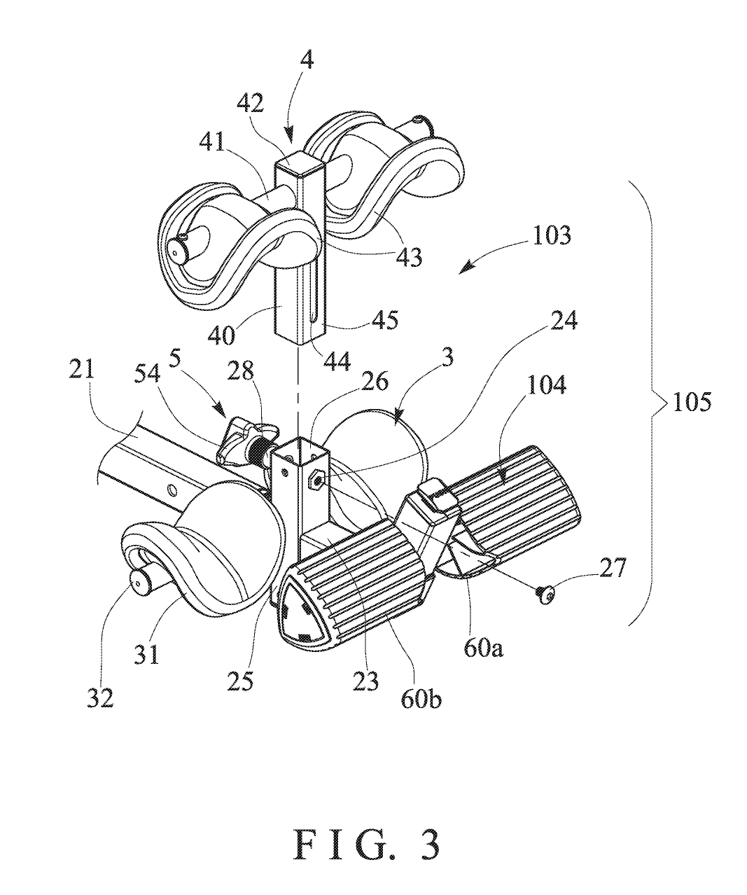

As shown in FIG. 3, the stem 40 defines or includes an oblong hole or slot 44 formed in and extending through a lower portion or first surface 45 thereof. A hole extends through a lower surface or sidewall of the shank 25, and a threaded nut 24 is welded onto the shank 25 in alignment with the hole. A set screw or fastener 27 is threaded through the nut 24 and into the slot 44 to slidably engage the slot 44 and thereby limit movement of the stem 40 relative to the shank 25 and preventing the stem 40 from being withdrawn from the shank 25.

The stem 40 further defines or includes one or more holes or orifices 46 formed in and extending through an upper portion or second surface 47 thereof. The holes 46 cooperate with a lock device 5 to secure the front ankle holder 4 in a desired location relative to the rear ankle holder 3. In this regard, a hole extends through an upper surface or sidewall of the shank 25, and a barrel or tubular member 28 is welded onto the shank in alignment with the hole. The barrel 28 extends perpendicularly upward from the shank 25 and defines a bore 29 in communication with the chamber 26 defined by the shank 25 to accommodate the latch or lock device 5.

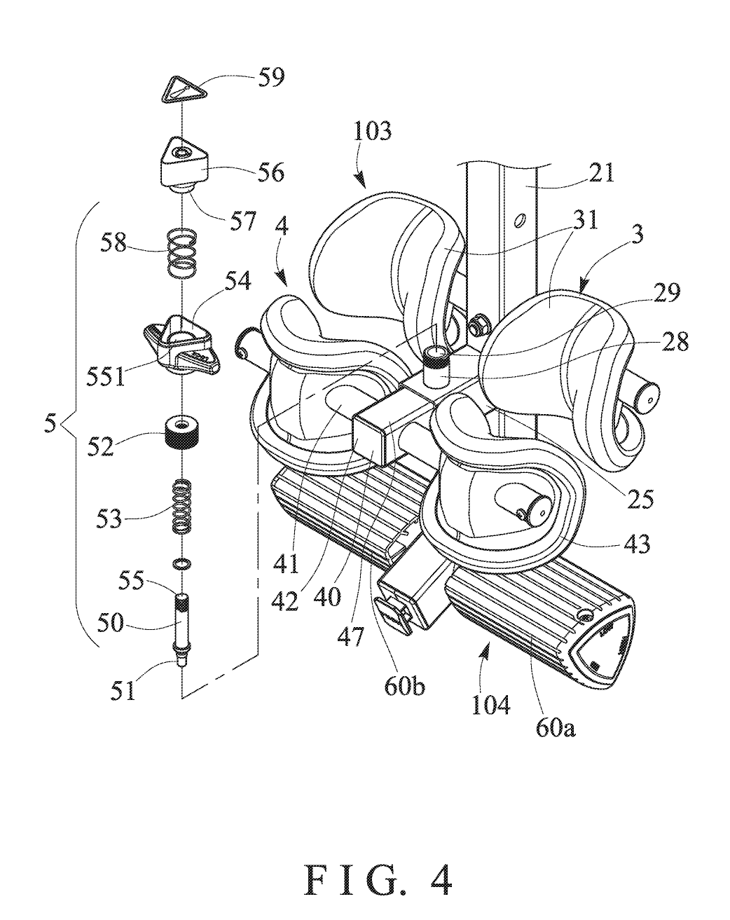

As shown in FIG. 4, the lock device 5 includes a pole or rod 50 slidably received or engaged in the bore 29 of the tubular member 28. The rod 50 includes a tip or tongue 51 formed or provided on the lower end portion thereof for selectively engaging with the orifices 46, thereby anchoring or retaining or latching the stem 40 (and the cuffs 43) in a desired position relative to the shank 25. A cap or cover 52 is threaded or engaged with the tubular member 28 for anchoring or retaining or positioning the rod 50 to the tubular member 28, and for preventing the rod 50 from being disengaged from the tubular member 28. A helical coil spring or biasing member 53 is disposed or compressed between the rod 50 and the cover 52 for biasing and forcing or moving the tongue 51 of the rod 50 to engage with an aligned one of the orifices 46 of the stem 40.

FIG. 5 shows the tongue 51 of the rod 50 biased and forced and moved to occupy or engage with an aligned one of the orifices 46 of the stem 40. As a result, the stem 40 and the foot anchor members 43 are anchored or retained or positioned to the shank 25 at a first selected or desired position. FIG. 6 shows the tongue 51 of the rod 50 selectively moved and disengaged from the stem 40 (by the user pulling upward on the rod 50) to allow the stem 40 and the foot anchor members 43 to be adjusted and moved relative to the pads 31 of the ankle holder 3 and the shank 25. FIG. 7 shows the stem 40 and the foot anchor members 43 moved to an alternative position but with the rod 50 still held outward by the user. FIG. 8 shows the tongue 51 of the rod 50 biased and forced and moved to occupy and engage with another aligned orifice 46 of the stem 40 after the rod 50 is released by the user. As a result, the stem 40 and the foot anchor members 43 are anchored or retained or positioned to the shank 25 at a second selected or desired position.

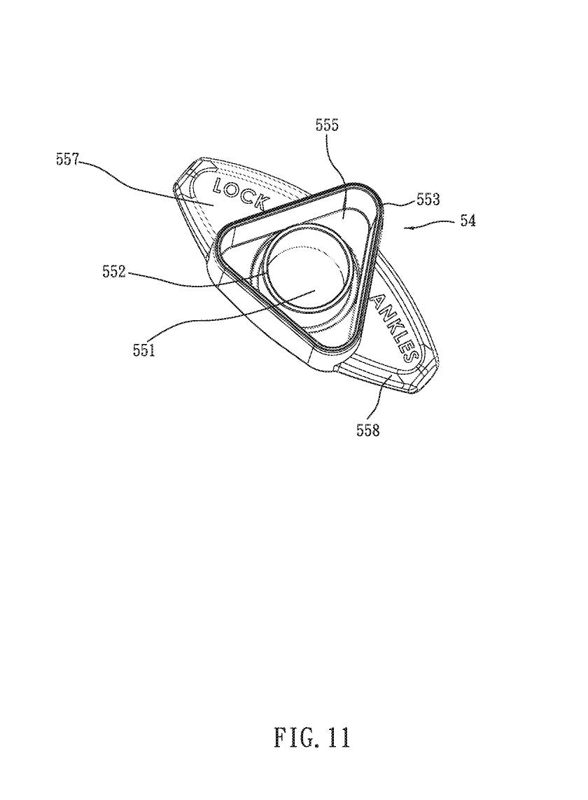

With reference to FIGS. 4 and 11, the lock device 5 includes a knob 54 having a centrally located cylindrical tube or 552 disposed inside a triangular shell 553. The tube 552 is open at both ends and thus, defines an aperture 551 that extends longitudinally through the knob 54. The shell 553 is upwardly open but closed at the bottom in the space between the tube 552 and the shell 553. In other words, a bottom wall 555 extends between the lower end of the tube 552 and the lower end of the shell 553. Left and right tabs 557 and 558 extend laterally outward in diametrically opposite directions from the triangular shell 553 to help a user pull the knob 54 away from the cap 52.

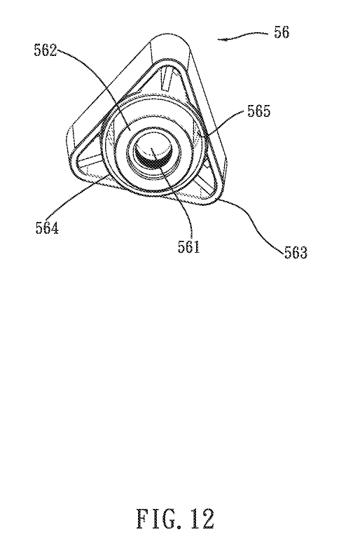

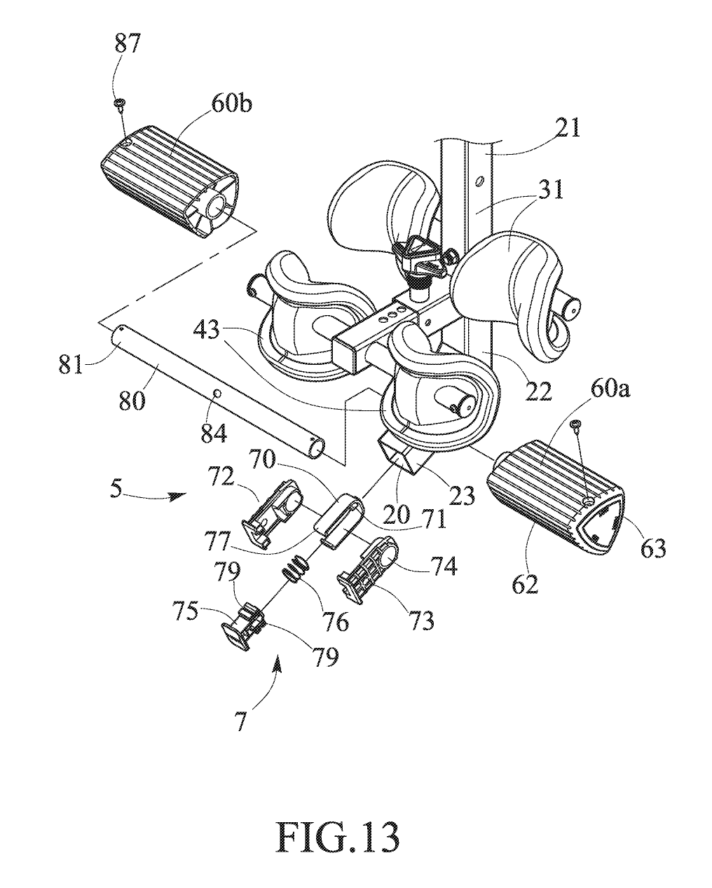

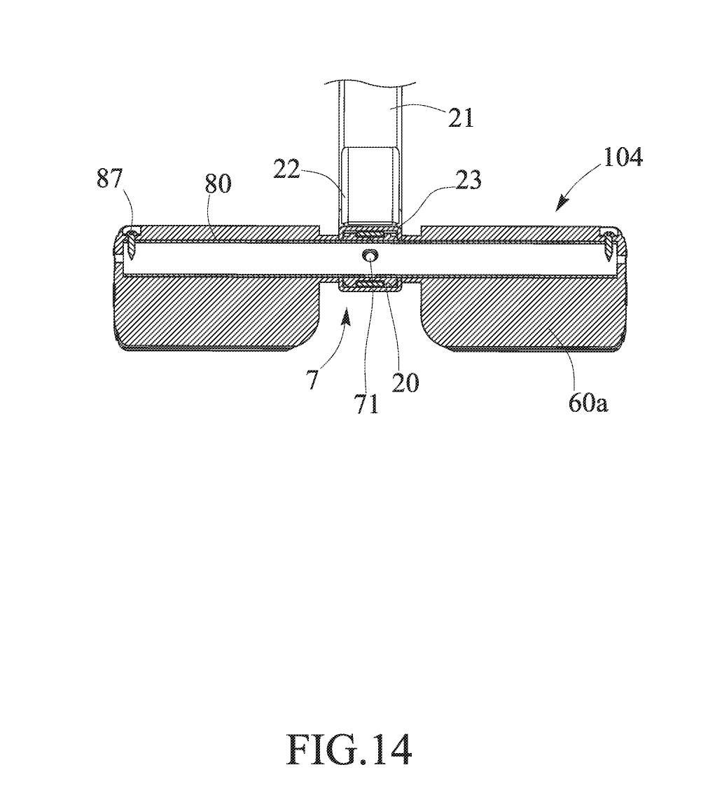

With reference to FIGS. 4 and 12, the lock device 5 also includes a button 56 having a centrally located cylindrical tube 562 disposed inside a triangular shell 563. The triangular shell 563 on the button 56 is sized and configured to register with and telescope within the triangular shell 553 on the knob. The tube 562 on the button 56 is sized and configured to telescope within the triangular shell 552 on the knob 54. The tube 562 is open at both ends and thus, defines an aperture 561 that extends longitudinally through the button 56. A second cylindrical tube 564 is concentrically nested between the tube 562 and the shell 563, and cooperates with the tube 562 to define a cylindrical shell of space 565. The tube 564 is downwardly open but closed at the top in the space between the tubes 562 and the shell 564. In other words, a top wall extends between the upper end of the tube 562 and the upper end of the tube 564.

As perhaps best seen in FIGS. 4 and 10, a helical coil spring or biasing member 58 occupies and is disposed inside the cylindrical shell of space 565 defined by the button 56. The rod 50 has an upper portion or exposed end 55 that projects upward from the cap 52, passes through the aperture 551 in the knob 54 and through the spring 58, and is threaded into the aperture in the button 56 (with the triangular shell 563 registered inside the triangular shell 553). As a result of this arrangement, the knob 54 is slidably mounted on the button 56 (and relative to the rod 50). In the absence of other forces, the spring 58 biases the knob 54 downward and away from the button 56. However, the bias or strength of the spring 58 is less than the bias or strength of the spring 53. As a result, the spring 53 overpowers or dominates the spring 58 when the tongue 51 of the rod 50 occupies one of the orifices 46 (as shown in FIGS. 5 and 8).

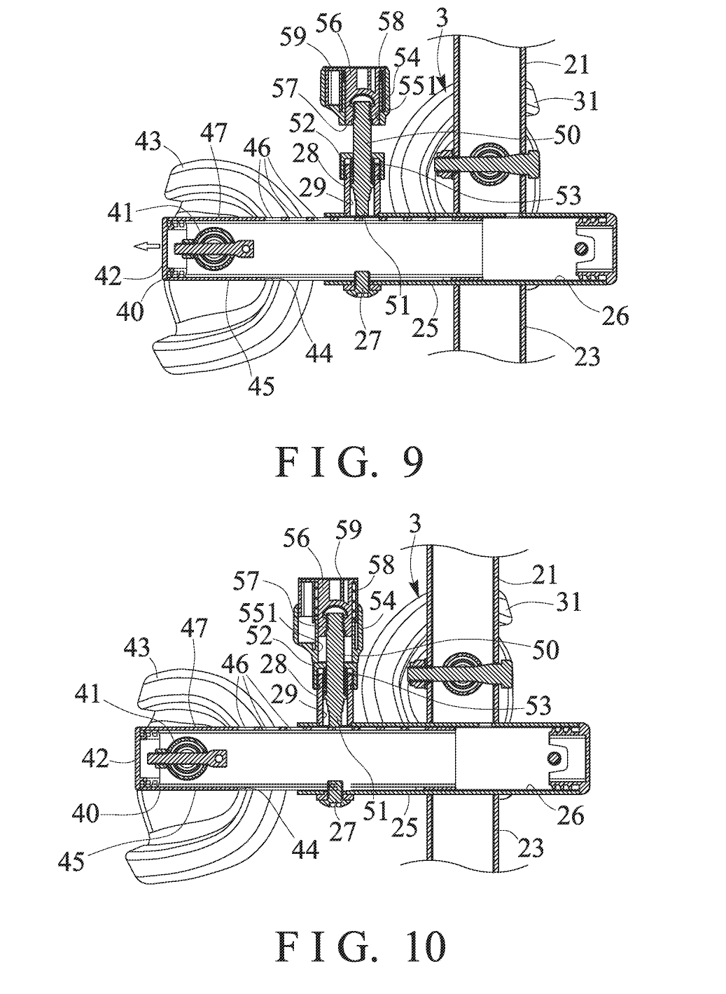

FIG. 9 shows the tongue 51 of the rod 50 in a position between two of the orifices 46 of the stem 40 (with the user continuing to hold the knob 54 upward). FIG. 10 shows what happens when the user releases the knob 54 in this unaligned position (with the spring 53 captured or forced to remain in a compressed state). In the absence of both user applied upward force on the knob 54 and downward force of the spring 53 on the rod (and the button 56), the spring 58 biases and forces and moves the knob 54 downward away from the button 56 (into the gap shown in FIG. 9), thereby causing the button 56 to be exposed or separated from the knob 54.

A tag or label 59 is preferably mounted on top of the button 56 to call attention to the exposed or protruding button 56 and/or the label 59 and provide or indicate a warning signal that the tongue 51 of the rod 50 is not engaged with any of the orifices 46 of the stem 40. In this misaligned position, the stem 40 and the cuffs 43 are free to move relative to the cuffs 31, meaning the feet of the user may not be solidly and stably anchored or retained or positioned to the extension 21 for purposes of inversion.

In operation, the tilting inversion exerciser in accordance with the present invention includes an ankle holder for adjustably securing the ankle portions of the user, and for giving some security to the user while conducting the inversion exercises, and for preventing the feet of the user from being inadvertently disengaged from the foot and ankle engaging assembly, and thus for allowing the user to safely conduct inversion exercise.

The foot rest 104 is attached or mounted or secured to a bottom or distal end portion 22 of the extension 21 (beneath the shank 25). The foot rest 104 includes one or more and preferably two foot pedals 60a and 60b sized and configured to underlie and stabilize and support the feet F of the user, and/or to be stepped on by the feet F of the user. In this regard, a square tube or shank or support 23 is welded to the lower end of the distal end portion 22, and extends forward and downward from the end portion 22. The tube 23 defines a chamber or compartment 20 that opens forwardly in a direction generally away from the extension 21. The left and right foot pedals 60a and 60b are selectively rotatably mounted to the tube 23. As further described below, a lock assembly or device 7 is sized and configured for insertion into the open forward end of the chamber 20.

A cylindrical tube or hollow rod 80 extends laterally through holes in the sidewalls of the tube 23 and through an aligned opening in the device 7 to secure the device 7 inside the tube 23. The left foot pedal 60a slides onto an outwardly projecting left end of the rod 80, and the right foot pedal 60b slides onto an outwardly extending right end of the rod 80. Screws 87 insert through holes in respective foot pedals 60a and 60b, and thread into aligned holes 81 in respective ends of the rod 80 to fasten the foot pedals 60a and 60b to the rod 80 and capture the tube 23 therebetween. In the absence of other influences, this arrangement rotatably mounts the rod 80 (and the foot pedals 60a and 60b) on the tube 23 for rotation about a longitudinal axis defined by the rod 80. In terms of structure, the left pedal 60a and the right pedal 60b are mirror images of one another.

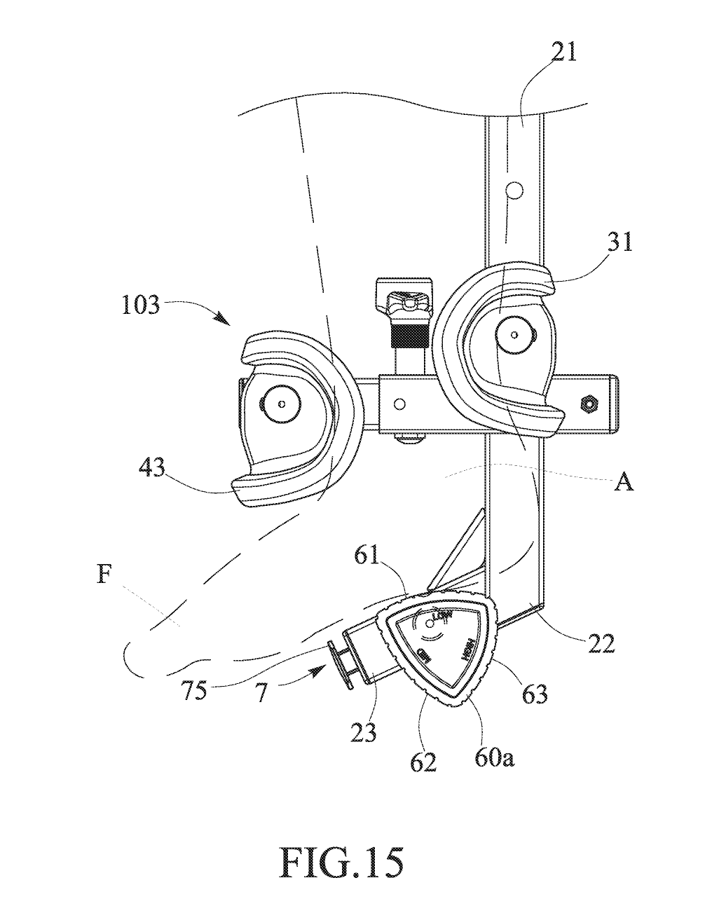

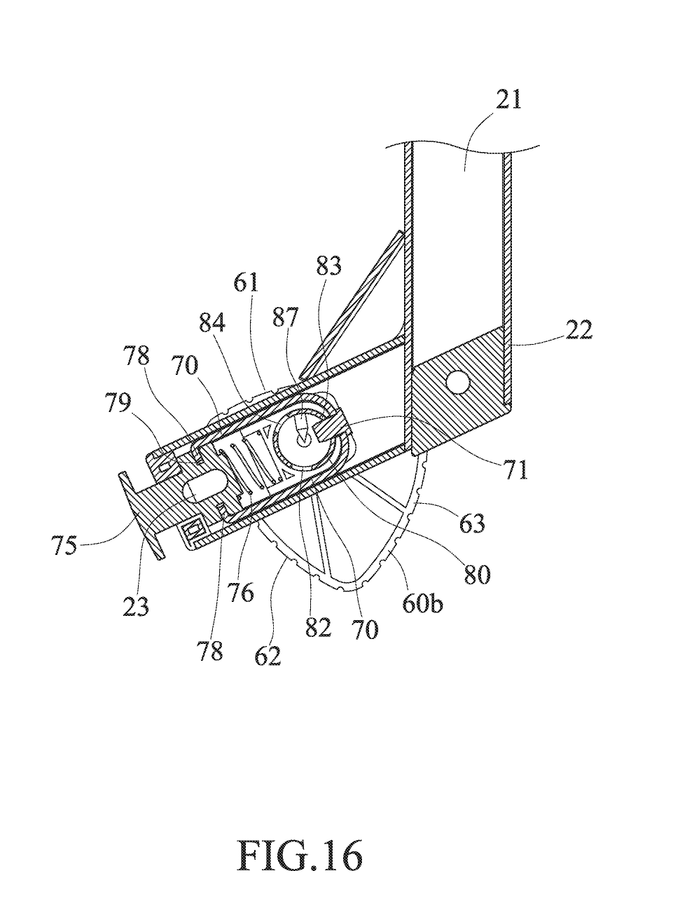

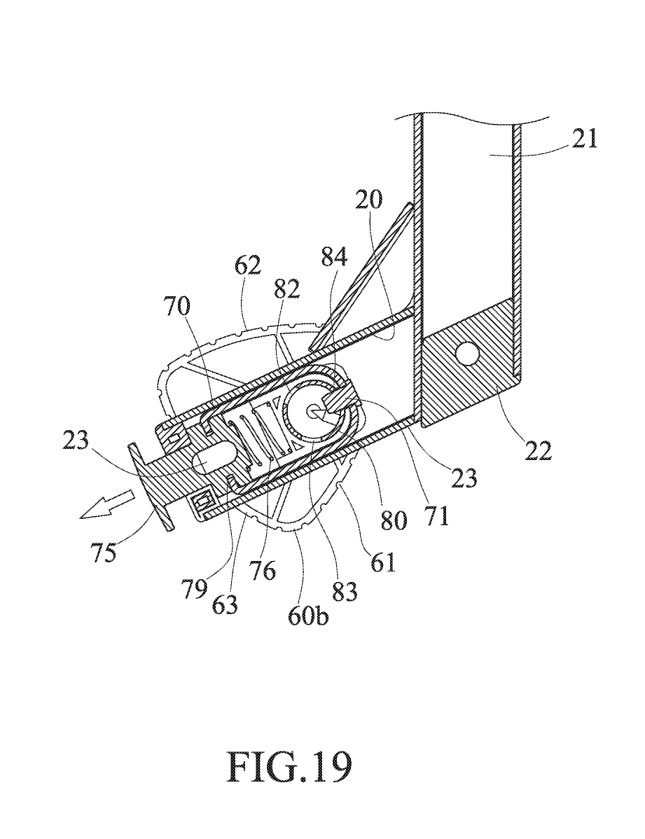

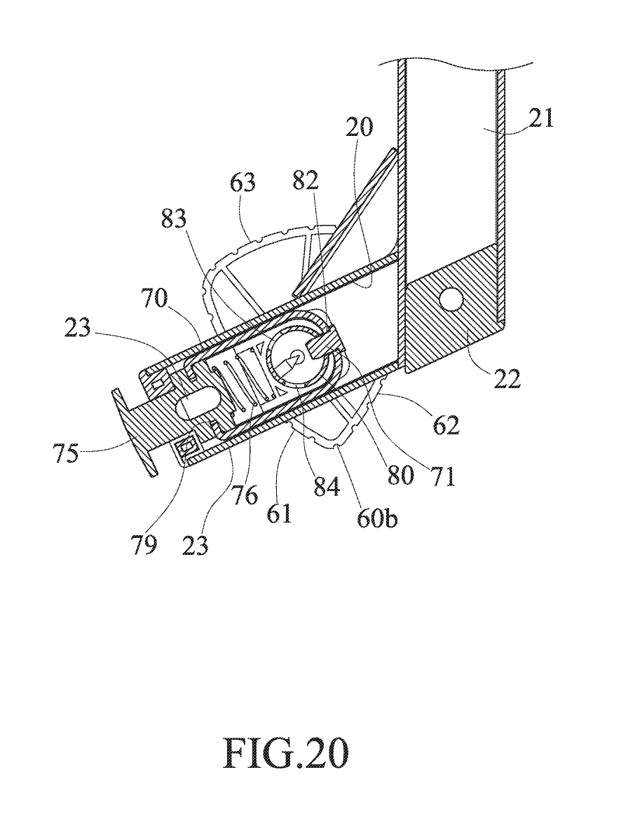

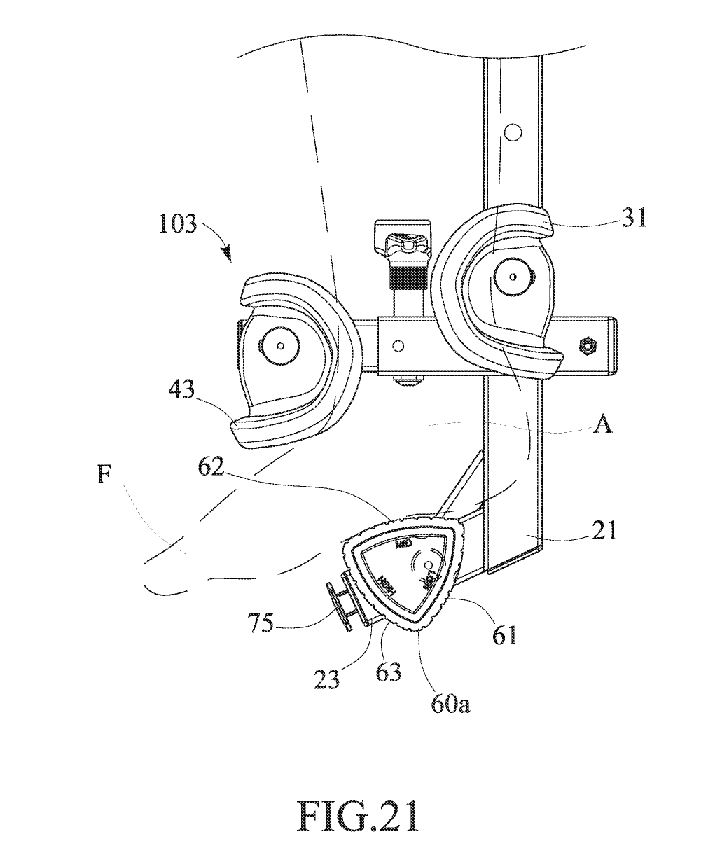

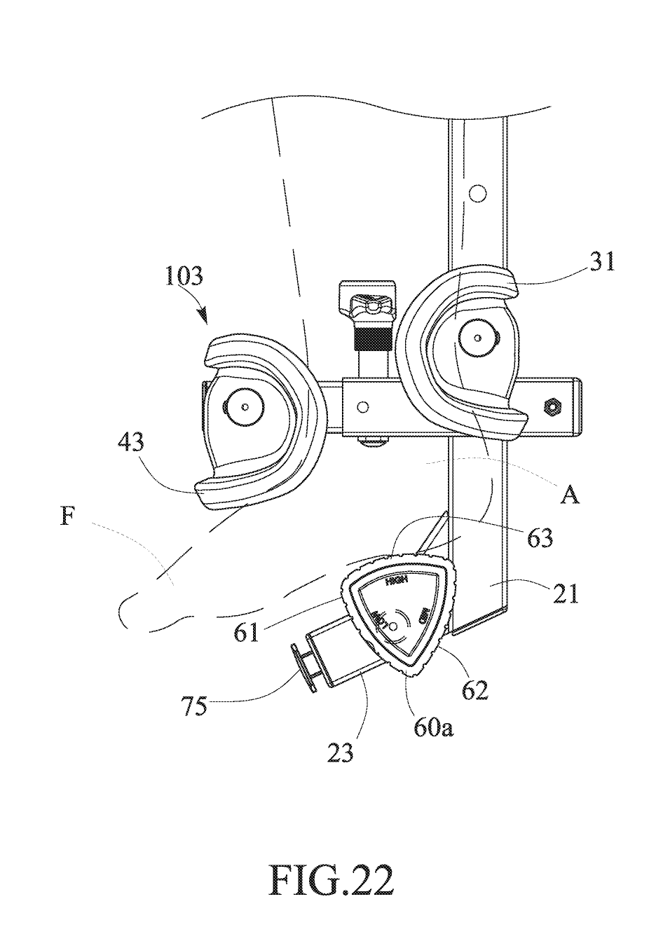

The left and right pedals 60a and 60b share a common eccentricity relative to the rod 80, and each includes a plurality of and preferably three alternative foot bearing surfaces 61-63 disposed about the outer peripheral portion thereof. Each surface 61-63 is arranged and located at a different radius or spacing distance from the rod 80, and thus, establishes a different foot supporting location relative to the rod 80 and the support 25 associated with the ankle holder 103. For example, FIGS. 15 and 16 show the lower or first surfaces of the foot pedals 60a and 60b positioned to underlie the feet 80 of the user; and FIGS. 19 and 21 show the medium or second surfaces 62 of the foot pedals 60a and 60b positioned to underlie the feet 80 of the user; and FIGS. 20 and 22 show the higher or third surfaces 63 of the foot pedals 60a and 60b positioned to underlie the feet 80 of the user. In other words, the surfaces 61, 62, 63 of the foot pedals 60 may support the feet 80 of the user at respective positions or locations or heights relative to the longitudinal axis of the rod 80.

The rod 80 has or defines one or more and preferably three holes or orifices 82-84 formed through the middle or intermediate portion of the rod 80. The orifices 82-84 occupy respective circumferentially spaced locations at a common axial location along the rod 80. The axial location of the orifices 82-84 aligns with the center of the tube 23 and places the orifices 82-84 in communication with the chamber 20 defined by the tube 23.

The latch or lock device 7 is disposed or engaged in the chamber 20 of the tube 23, and may be described as a means for releasably latching or locking the rod 80 and the foot pedals 60a and 60b in the different angular positions. The lock device 7 includes a casing or lever or bar comprised of two identical left and right inserts or halves 72 and 73, one of which is flipped 180 degrees relative to the other. The inserts 72 and 73 are sized and configured to come together and register or mate with one another in a manner that defines a through hole 74. After the device 7 is assembled and inserted into the chamber 20, the rod 80 is inserted through the hole 74 and the aligned holes in the sidewalls of the tube 23, as described above.

The inserts 72 and 73 cooperate to retain three movable parts therebetween. In this regard, the inserts 72 and 73 have inner end portions that define a stepped down rail that extends between relatively larger flanges on respective inserts 72 and 73. The hole 74 extends through a central portion of the rail. A U-shaped follower or first movable part 70 is configured to straddle the rail between the flanges. The follower 70 has an inner end or base portion that wraps or curves around the distal inner end of the rail, which in turn, wraps or curves around the rod 80. The base portion supports a peg or tongue or projection 71 that projects away from the base portion of the follower 70 and toward the rod 80. The follower 70 has first and second legs or prongs 77 that extend away from respective ends of the base portion to respective outer ends, which are bent toward one another to define first and second tabs 78.

The inserts 72 and 73 have outer end portions that define a lipped or rimmed opening proximate the open front edge of the chamber 20. The rimmed opening has a square profile that nest concentrically inside the square profile of the chamber 20. The inserts 72 and 73 also have intermediate portions that define a channel between the rimmed opening and the rail.

A knob or button or second movable part 75 has an inner end portion sized and configured to fit between the prongs 77 on the follower 70 and to resist extraction from the chamber 20 through the rimmed opening. The inner end portions defines first and second grooves or slots 79 that open in opposite directions to receive and retain respective tabs 78. A helical coil spring or bias member or third movable part 76 is placed in series or compressed between a distal inner end of the knob 75 and an opposing end of the rail, thereby biasing the knob 75 away from the rail (and away from the inserts 72 and 73). The knob 75 has a stepped down intermediate portion or neck that extends through the rimmed opening, and an outer end disposed outside the inserts 72 and 73, and sized and configured to be pushed by the thumb or fingers of the user.

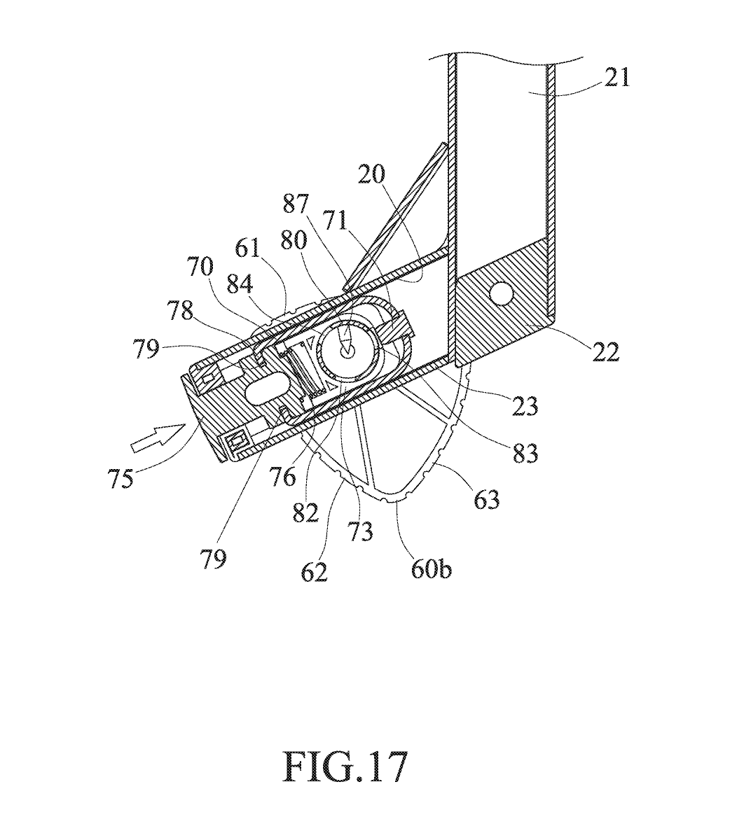

The foregoing arrangement is such that the knob 75 is slidable relative to the inserts 72 and 73 between a relaxed or latched or extended position, shown FIG. 16, and an active or unlatched or inserted position, shown in FIG. 17. The spring 76 biases the knob 75 toward the position shown in FIG. 16, which in turn biases the projection 71 on the follower 70 to occupy one of the orifices 82-84 in the tube 80. In other words, the knob is depressed and actuated by the user to disengage or remove the projection 71 from the tube 80.

FIGS. 15 and 16 show the projection 71 of the follower 70 biased and forced and moved to engage with the aligned orifice 83, and the button 75 occupying its extended or rest position, projecting outward from the tube 23. The rod 80 and the foot pedals 60a and 60b are thus anchored or retained or positioned at the selected angular position, the surfaces 61 at a first selected or required position or location for engaging with and supporting the feet F of the user at a first spacing distance or height relative to the tube 80 (and the ankle holder 103).

FIG. 17 shows the knob 75 depressed and actuated by the user (see the arrow pointing toward the button 75) and moved against the spring biasing member 76 to its compressed or inserted position, proximate the distal end of the tube 23. When the knob 75 occupies this position, the projection 71 of the follower 70 is disengaged and removed from the aligned orifice 83, thereby releasing or allowing the tube 80 and the foot pedals 60a and 60b to be rotated relative to the tube 23 to a more desirable angular position or orientation.

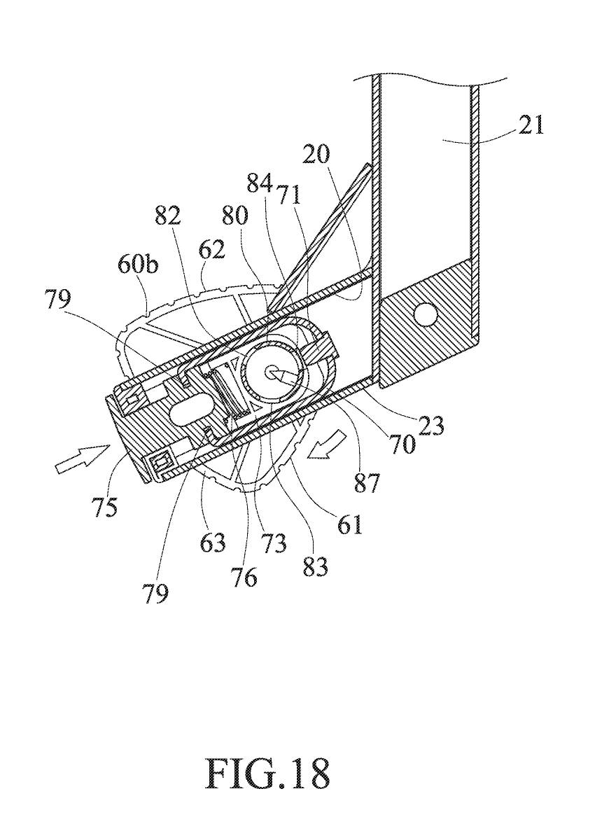

FIG. 18 shows the foot pedal 62b rotated one hundred and twenty degrees counter-clockwise (see the arrow at 5:00 relative to the rod 80), while pressure is maintained on the knob 75 (see the arrow pointing toward the button 75). This rotational adjustment of the rod 80 places or positions the orifice 84 in alignment with the projection 71 of the follower 70, and the surface 62 in an operative position relative to the user's feet F.

FIGS. 19 and 21 show the projection 71 of the follower 70 biased and forced and moved to engage with the aligned orifice 84, and the knob 75 occupying its extended or rest position, projecting outward from the tube 23 (see the arrow pointing away from the knob 75). The rod 80 and the foot pedals 60a and 60b are thus anchored or retained or positioned at the selected angular position, with the surfaces 62 at a second selected or required position or location for engaging with and supporting the feet F of the user at a second spacing distance or height relative to the tube 80 (and the ankle holder 103).

FIGS. 20 and 22 show the projection 71 of the follower 70 biased and forced and moved to engage with the aligned orifice 82, and the knob 75 occupying its extended or rest position, projecting outward from the tube 23. The rod 80 and the foot pedals 60a and 60b are thus anchored or retained or positioned at the selected angular position, with the surfaces 63 at a third selected or required position or location for engaging with and supporting the feet F of the user at a third spacing distance or height relative to the tube 80 (and the ankle holder 103).

In operation, the tilting inversion exerciser in accordance with the present invention includes a foot rest for adjustably supporting the feet of the user, and for giving security to the user while conducting the inversion exercises, and/or for preventing the feet of the user from being inadvertently disengaged from the foot rest, and thus for allowing the user to safely conduct inversion exercise.

The subject invention may also be described as follows:

A1. A tilting inversion exerciser, comprising:
a supporting stand;
a table tiltably supported on said supporting stand, wherein the table includes a platform configured to support a user and an extension connected to an end of the platform;
a foot rest attached to said extension; and
an ankle holder attached to said extension, said ankle holder including:
   a rear ankle support attached to said extension and adapted for engaging with the backs of a user's ankles;
   a stem slidably attached to said extension;
   a front ankle support attached to said stem for selective movement with said stem relative to said rear ankle support; and
   a lock device including a rod having a tongue for selectively engaging with one of a plurality of openings in said stem to latch said stem and the front ankle support at a respective one of a plurality of distances from the rear ankle support.

A2. The tilting inversion exerciser of A1, wherein said extension includes a shank extended from said extension and perpendicular to said extension, said shank includes a chamber formed therein for slidably receiving and engaging with said stem.

A3. The tilting inversion exerciser of A2, wherein said stem includes a hole formed therein, and said extension includes a fastener attached to said shank and slidably engaged in said hole of said stem for guiding and limiting said stem to move relative to said shank and for preventing said stem from being disengaged from said shank.

A4. The tilting inversion exerciser of A1, wherein a spring biasing member is engaged with said rod for biasing and forcing said tongue of said rod to engage with said stem.

A5. The tilting inversion exerciser of A1, wherein said stem includes a plurality of orifices formed therein for selectively engaging with said tongue of said rod.

A6. The tilting inversion exerciser of A1, wherein said extension includes a shank extended from said extension, said shank includes a tubular member extended from said shank, and said tubular member includes a bore formed therein for slidably receiving and engaging with said rod.

A7. The tilting inversion exerciser of A6, wherein said extension includes a cover engaged with said tubular member for anchoring said rod to said tubular member and for preventing said rod from being disengaged from said tubular member.

A8. The tilting inversion exerciser of A6, wherein said lock device includes a button attached to said rod.

A9. The tilting inversion exerciser of A8, wherein said lock device includes a knob having an aperture formed in said knob for partially and slidably engaging with said rod, and said button includes a barrel slidably engaged in said aperture of said knob.

A10. The tilting inversion exerciser of A9, wherein said lock device includes a spring biasing member engaged between said knob and said button for biasing and forcing said knob and said button away from each other selectively.

A11. The tilting inversion exerciser of A9, wherein said lock device includes a warning tag attached to said button.

B1. An inversion apparatus, comprising:
a base configured to rest on an underlying floor surface;
a body supporting table movably supported on said base for tilting relative to said base to at least a partially inverted orientation relative to the floor surface; and
an ankle holder mounted on said body supporting table, said ankle holder including (a) a frame member; (b) at least one rear ankle support mounted on said frame member, wherein said at least one rear ankle support is sized and configured to engage a user's ankles from behind; (c) a telescoping member movably connected to said frame member for selective telescoping movement relative thereto; (d) at least one front ankle support mounted on said telescoping member, wherein said at least one front ankle support is sized and configured to engage a user's ankles from in front; and (e) a locking member sized and configured for selective insertion through discrete combinations of aligned openings in said telescoping member and said frame member for locking said telescoping member in respective, discrete positions relative to said frame member.

B2. The inversion apparatus of claim B1, wherein the frame member includes a bar that defines a longitudinal direction, and a tube mounted on the bar to extend perpendicular to the longitudinal direction, wherein the telescoping member is slidably mounted inside the tube.

B3. The inversion apparatus of claim B2, wherein the locking member includes a rod that selectively moves perpendicular to the tube and into said aligned openings.

B4. The inversion apparatus of claim B3, wherein the locking member further includes a warning button movably connected to the rod and biased to project upward from the rod when the rod comes to rest between aligned openings.

B5. The inversion apparatus of claim B1, wherein the locking member further includes a warning button biased to project upward when the locking member comes to rest in a disengaged position relative to said telescoping member.

C1. A tilting inversion exerciser, comprising:
a supporting stand;
a table tiltably supported on said supporting stand, wherein the table includes a platform configured to support a user and an extension connected to an end of the platform;
an ankle holder attached to said extension; and
a foot rest attached to said extension, said foot rest including:
   a rod rotatably attached to said extension;
   a foot pedal attached to said rod and rotated in concert with said rod relative to said extension, said foot pedal including a plurality of surfaces disposed about an outer peripheral portion of said foot pedal and arranged at different radial distances relative to said rod, and alternatively directed toward said ankle holder for engaging with a foot of a user.

C2. The tilting inversion exerciser of C1, wherein said extension includes a shank extended from said extension for supporting said foot rest.

C3. The tilting inversion exerciser of C2, wherein said shank is skewed relative to said extension.

C4. The tilting inversion exerciser of C2, said foot rest includes a right said foot pedal fastened to a left end of said rod, and a left said foot pedal fastened to a right end of said rod.

C5. The tilting inversion exerciser of C4, wherein said foot rest includes a lock device attached to said shank for selectively engaging with said rod and for anchoring said rod and said foot pedal at a selected angular position.

C6. The tilting inversion exerciser of C5, wherein said rod includes a first orifice and at least one second orifice formed therein, and said lock device includes a projection for selectively engaging with either of said first or said at least one second orifice of said rod and for anchoring said rod and each said foot pedal at the selected angular position.

C7. The tilting inversion exerciser of C6, wherein said lock device includes a follower, and said projection is extended from said follower.

C8. The tilting inversion exerciser of C7, wherein said lock device includes a knob attached to said follower for selectively moving said follower relative to said rod.

C9. The tilting inversion exerciser of C8, wherein said lock device includes a bar engaged with said rod.

C10. The tilting inversion exerciser of C9, wherein said lock device includes a spring biasing member engaged between said bar and said knob for biasing said projection to engage with an aligned said orifice of said rod.

C11. The tilting inversion exerciser of C10, wherein said bar includes an aperture formed therein for receiving and engaging with said rod.

D1. An inversion apparatus, comprising:
a base configured to rest on a floor surface;
a body supporting table movably supported on said base for tilting relative to said base, wherein the body supporting table includes a lower end that moves between a ready position disposed at a first height above the floor surface and an active position disposed at a relatively greater, second height above the floor surface;
a support mounted on said body supporting table to suspend a person against gravitational force when the body supporting table occupies said active position; and
a foot engaging member rotatably connected to said body supporting table for rotation relative to said body supporting table between a first orientation, wherein said foot engaging member engages a user's foot at a first distance from the lower end, and a second orientation, wherein said foot engaging member similarly engages a user's foot, but at a relatively greater, second distance from the lower end.

D2. The inversion apparatus of claim D1, wherein the foot engaging member includes a rod, a left foot pedal eccentrically mounted on a left end of the rod, and a right foot pedal eccentrically mounted on a right end of the rod.

D3. The inversion apparatus of claim D2, wherein each said foot pedal is fastened to the rod, and the rod is rotatably connected to said body supporting table.

D4. The inversion apparatus of claim D3, further comprising a peg biased into rotation locking engagement with the rod when the rod occupies either said orientation.

D5. The inversion apparatus of claim D4, wherein the rod defines circumferentially spaced openings, including a first opening that receives the peg when the foot engaging member occupies the first orientation, and a second opening that receives the peg when the foot engaging member occupies the second orientation.

D6. The inversion apparatus of claim D5, further comprising a button connected to the peg and biased to project away from the rod when the peg occupies either said opening.

D7. The inversion apparatus of claim D1, wherein said foot engaging member is selectively rotatable to a third orientation, wherein the foot engaging member similarly engages a user's foot, but at an even greater, third distance from the lower end.

E1. An inversion apparatus, comprising:
a base configured to rest on a floor surface;
a body supporting table movably supported on said base for tilting relative to said base; and
a foot engaging member rotatably mounted on said body supporting table for rotation about an axis relative to said body supporting table, wherein said foot engaging member defines a first foot engaging surface at a first radial distance from said axis and an alternative second foot engaging surface at a relatively greater, second radial distance from said axis.

E2. The inversion apparatus of claim E1, wherein said foot engaging member defines a third foot engaging surface at a third radial distance from said axis.

E3. The inversion apparatus of claim E2, wherein when viewed axially, the foot engaging member has a triangular periphery, and each said surface defines a respective side of the triangular periphery. E4. The inversion apparatus of claim E1, wherein a tube is fastened to the body supporting table, and the foot engaging member includes a rod rotatably mounted on the tube.

E5. The inversion apparatus of claim E4, wherein a plunger is slidably mounted inside the tube and aligns with an intermediate portion of the rod, and circumferentially spaced apart first and second openings extend into the rod at said intermediate portion to receive the plunger when the foot engaging member occupies a respective said orientation.

E6. The inversion apparatus of E5, further comprising a button connected to the plunger and biased to project outward from an end of the tube when the peg occupies either of said openings.

The subject invention may also be described in terms of methods with reference to the foregoing embodiments. For example, the subject invention may be described in terms of a method of clamping one's ankle on an inversion apparatus, comprising the steps of providing an inversion apparatus having a frame, an inversion table movably mounted on the frame, and an ankle clamping assembly mounted on the inversion table, the ankle clamping assembly including a rear ankle brace, a front ankle brace, and a telescoping member interconnected between the rear ankle brace and the front ankle brace; placing one's ankle between the front ankle brace and the rear ankle brace; and operating the telescoping member to bring the front ankle brace closer to the rear ankle brace until the ankle is clamped therebetween.

The subject invention has been described with reference to preferred embodiments and particular applications with the understanding that persons skilled in the art will arrive at various modifications to the disclosed embodiments and/or their applications without departing from the scope of the subject invention. In view of the foregoing, the subject invention should be limited only to the extent of allowable claims that issue from this application or any related application.

What is claimed is:

1. A tilting inversion exerciser, comprising:
a supporting stand;
a table tiltably supported on said supporting stand, wherein the table includes a platform configured to support a user and an extension connected to an end of the platform;
a foot rest attached to said extension; and
an ankle holder attached to said extension, said ankle holder including:
a rear ankle support attached to said extension and adapted for engaging with the backs of a user's ankles;
a stem slidably attached to said extension;
a front ankle support attached to said stem for selective movement with said stem relative to said rear ankle support; and
a lock device including a rod having a tongue for selectively engaging with one of a plurality of openings in said stem to latch said stem and the front ankle support at a respective one of a plurality of distances from the rear ankle support.

2. The tilting inversion exerciser of 1, wherein said extension includes a shank extended from said extension, said shank includes a chamber formed therein for slidably receiving and engaging with said stem.

3. The tilting inversion exerciser of 2, wherein said stem includes a hole formed therein, and said extension includes a fastener attached to said shank and slidably engaged in said hole of said stem for guiding and limiting said stem to move relative to said shank and for preventing said stem from being disengaged from said shank.

4. The tilting inversion exerciser of 1, wherein a spring biasing member is engaged with said rod for biasing and forcing said tongue of said rod to engage with said stem.

5. The tilting inversion exerciser of 1, wherein said stem includes a plurality of orifices formed therein for selectively engaging with said tongue of said rod.

6. The tilting inversion exerciser of 1, wherein said extension includes a shank extended from said extension, said shank includes a tubular member extended from said shank, and said tubular member includes a bore formed therein for slidably receiving and engaging with said rod.

7. The tilting inversion exerciser of 6, wherein said extension includes a cover engaged with said tubular member for anchoring said rod to said tubular member and for preventing said rod from being disengaged from said tubular member.

8. The tilting inversion exerciser of 6, wherein said lock device includes a button attached to said rod.

9. The tilting inversion exerciser of 8, wherein said lock device includes a knob having an aperture formed in said knob for partially and slidably engaging with said rod, and said button includes a barrel slidably engaged in said aperture of said knob.

10. The tilting inversion exerciser of 9, wherein said lock device includes a spring biasing member engaged between said knob and said button for biasing and forcing said knob and said button away from each other selectively.

11. The tilting inversion exerciser of 9, wherein said lock device includes a warning tag attached to said button.

12. An inversion apparatus, comprising:
a base configured to rest on an underlying floor surface;
a body supporting table movably supported on said base for tilting relative to said base to at least a partially inverted orientation relative to the floor surface; and
an ankle holder mounted on said body supporting table, said ankle holder including (a) a frame member; (b) at least one rear ankle support mounted on said frame member, wherein said at least one rear ankle support is sized and configured to engage a user's ankles from behind; (c) a telescoping member movably connected to said frame member for selective telescoping movement relative thereto; (d) at least one front ankle support mounted on said telescoping member, wherein said at least one front ankle support is sized and configured to engage a user's ankles from in front; and (e) a locking member sized and configured for selective insertion through discrete combinations of aligned openings in said telescoping member and said frame member for locking said telescoping member in respective, discrete positions relative to said frame member.

13. The inversion apparatus of claim 12, wherein the frame member includes a bar that defines a longitudinal direction, and a tube mounted on the bar to extend perpendicular to the longitudinal direction, wherein the telescoping member is slidably mounted inside the tube.

14. The inversion apparatus of claim 13, wherein the locking member includes a rod that selectively moves perpendicular to the tube and into said aligned openings.

15. The inversion apparatus of claim 14, wherein the locking member further includes a warning button movably connected to the rod and biased to project upward from the rod when the rod comes to rest between aligned openings.

16. The inversion apparatus of claim 12, wherein the locking member further includes a warning button biased to project upward when the locking member comes to rest in a disengaged position relative to said telescoping member.

17. A method of clamping one's ankle on an inversion apparatus, comprising the steps of:
providing an inversion apparatus having a frame, an inversion table movably mounted on the frame, and an ankle clamping assembly mounted on the inversion table, the ankle clamping assembly including a rear ankle brace, a front ankle brace, and a telescoping member interconnected between the rear ankle brace and the front ankle brace;
placing one's ankle between the front ankle brace and the rear ankle brace; and
operating the telescoping member to bring the front ankle brace closer to the rear ankle brace until the ankle is clamped therebetween.
